(19) United States
(12) Patent Application Publication
(10) Pub. No.: US 2026/0056007 A1
(43) Pub. Date: Feb. 26, 2026

(54) Sensor Arrangement and Method for Detecting a Rotational Movement of a Body that can Rotate About a Rotational Axis

(71) Applicant: Robert Bosch GmbH, Stuttgart (DE)

(72) Inventors: Michael Kleinknecht, Lehrensteinsfeld (DE); Stefan Kuntz, Flein (DE)

(21) Appl. No.: 19/105,801

(22) PCT Filed: Aug. 16, 2023
(86) PCT No.: PCT/EP2023/072536

§ 371 Date: Feb. 22, 2025

(30) Foreign Application Priority Data
Aug. 25, 2022 (DE) 10 2022 208 801.8

(51) Int. Cl. G01B 7/30; B62D 15/02; G01D 5/20

(52) U.S. Cl. CPC G01B 7/30; G01D 5/20; B62D 15/0215

(57) ABSTRACT

A sensor arrangement for acquiring a rotational movement of a body that can rotate about a rotational axis has at least three angle sensors and at least one evaluation and control unit. The at least three angle sensors each acquire the mechanical rotational movement of the rotatable body with a predefined transmission ratio and generate a corresponding electrical angle signal and output said angle signal to the at least one evaluation and control unit. The at least three angle sensors have different transmission ratios. The at least one evaluation and control unit are designed to determine a first angle of the rotatable body with a first uniqueness range by way of a first nonius calculation that is based on two electrical angle signals of the at least three electrical angle signals. The first uniqueness range of the determined first angle is greater than uniqueness ranges of the angle signals used for the calculation. The at least one evaluation and control unit is further designed to determine a second angle of the rotatable body with a second uniqueness range by way of a second nonius calculation that is based on the determined first angle and a further electrical angle signal of the at least three electrical angle signals. The second uniqueness range of the determined second angle is greater than the first uniqueness range of the determined first angle and a uniqueness range of the further electrical angle signal. Also disclosed is a method for acquiring a rotational movement of a body that can rotate about a rotational axis which can be carried out using such a sensor arrangement.

The invention relates to a sensor arrangement for acquiring a rotational movement of a body that can rotate about a rotational axis. The subject matter of the present invention also includes a method for acquiring a rotational movement of a body that can rotate about a rotational axis which can be carried out using such a sensor arrangement.

From the prior art it is known to calculate an absolute angle that is unique over several complete mechanical revolutions of a shaft from at least two angle signals using a nonius calculation, wherein at least one of the angle signals is mechanically reduced or increased relative to the rotational movement of the shaft, i.e. rotates less than or more than 360 degrees with one mechanical revolution of the shaft.

In a known inductive torque and steering angle sensor, two inductive angle measurements are typically used to calculate the torque and an additional, usually magnetic, angle measurement is used to calculate the steering angle with a uniqueness range of more than 360 degrees, because the intent is to acquire multiple revolutions of the steering wheel. According to the prior art, to calculate the absolute steering angle, an angle value acquired by means of the inductive angle measurements is transmitted to the control device where a nonius calculation is carried out with an angle value acquired by means of the additional magnetic angle measurement. This requires coordination of the periodicity of the additional magnetic angle measurement and the inductive angle measurements in order to ensure the functionality of the nonius calculation and to meet the customers' needs for the steering angle range to be measured. This coordination of the periodicities can lead to limitations in the inductive torque measurement, because certain periodicities are advantageous here for reducing measurement errors. Compensation often necessitates the use of larger gears that require a lot of installation space to reduce or increase the additional magnetic angle measurement.

An inductive torque and angle sensor for a steering mechanism which comprises an input shaft that is connected to an output shaft by a torsion rod is known from DE 11 2016 005 661 T5. A first coupler is connected to the input shaft, while a second coupler is connected to the output shaft. A first and a second receiving coil, which each comprise a large number of oppositely wound loops, are respectively disposed opposite the first or the second coupler, so that the first coupler lies above the first receiving coil and the second coupler lies above the second receiving coil. The angular offset between the two couplers is determined by a circuit. An angle sensor, which indicates the exact rotation angle of the steering wheel mechanism, is provided as well. To implement the angle sensor, a first gear is attached to the first coupler so that the first coupler and the first gear rotate in unison with one another. The first gear engages in a second gear that is mounted on an axis which is parallel to but spaced apart from the steering wheel torsion bar such that it can rotate relative to the printed circuit board. A coupler is mounted on the second gear and cooperates with the receiving coil of a third inductive sensor attached to the printed circuit board. A Hall effect sensor, or any other type of sensor such as an inductive Hall or (G)MR sensor, can be used to determine the angle of the second gear.

### DISCLOSURE OF THE INVENTION

The sensor arrangement for acquiring a rotational movement of a body that can rotate about a rotational axis with the features of the independent claim 1 and the method for acquiring a rotational movement of a body that can rotate about a rotational axis with the features of the independent claim 13 each have the advantage that the use of at least three angle signals in a cascaded nonius calculation improves the options for selecting the individual periodicities of the angle measurements and thus saves installation space. The cascaded nonius calculation also leads to increased robustness (k-decimal place) compared to a simple nonius calculation known from the prior art. Consequently, embodiments of the invention are thus less susceptible to angle errors and hysteresis errors. This advantageously enables the use of more cost-effective magnetic circuits and mechanical gear systems.

Embodiments of the present invention provide a sensor arrangement for acquiring a rotational movement of a body that can rotate about a rotational axis, comprising at least three angle sensors and at least one evaluation and control unit. The at least three angle sensors each acquire the mechanical rotational movement of the rotatable body with a predefined transmission ratio and each generate a corresponding electrical angle signal and output said signal to the at least one evaluation and control unit, wherein the at least three angle sensors have different transmission ratios. The at least one evaluation and control unit is designed here to determine a first angle of the rotatable body with a first uniqueness range by means of a first nonius calculation that is based on two electrical angle signals of the at least three electrical angle signals, wherein the first uniqueness range of the determined first angle is greater than uniqueness ranges of the angle signals used for the calculation. The at least one evaluation and control unit is further designed to determine a second angle of the rotatable body with a second uniqueness range by means a second nonius calculation that is based on the determined first angle and a further electrical angle signal of the at least three electrical angle signals, wherein the second uniqueness range of the determined second angle is greater than the first uniqueness range of the determined first angle and a uniqueness range of the further electrical angle signal.

A method for acquiring a rotational movement of a body that can rotate about a rotational axis which can be carried out using such a sensor arrangement is proposed as well. At least three electrical angle signals are generated and evaluated with a predefined transmission ratio on the basis of the mechanical rotational movement of the rotatable body, wherein the at least three electrical angle signals are acquired with different transmission ratios. A first angle of the rotatable body is determined with a first uniqueness range by means of a first nonius calculation that is based on two electrical angle signals of the at least three electrical angle signals, wherein the first uniqueness range of the determined first angle is greater than uniqueness ranges of the angle signals used for the calculation. A second angle of the rotatable body is determined with a second uniqueness range by means of a second nonius calculation that is based on the determined first angle and a further electrical angle signal of the at least three electrical angle signals, wherein the second uniqueness range of the determined second angle is greater than the first uniqueness range of the determined first angle and a uniqueness range of the further electrical angle signal.

In the present context, an evaluation and control unit can be understood to be an electrical assembly or electrical circuit that prepares or processes or evaluates acquired sensor signals or measurement signals. Preferably, the evaluation and control unit can be designed as an ASIC component (ASIC: application-specific integrated circuit). The evaluation and control unit can comprise at least one interface, which can be implemented as hardware and/or software. When implemented as hardware, the interfaces can be part of the ASIC component, for example. However, it is also possible that the interfaces are dedicated integrated circuits or consist at least partly of discrete components. When implemented as software, the interfaces can be software modules present, for example, on a microcontroller alongside other software modules.

Advantageous improvements to the sensor arrangement for acquiring a rotational movement of a body that can rotate about a rotational axis specified in the independent claim 1 and to the method specified in the independent claim 13 are made possible by the measures and further developments listed in the dependent claims.

It is particularly advantageous that the at least three angle sensors can each be embodied as an inductive angle sensor or as a magnetic angle sensor. For example, it is possible to embody all of the angle sensors as inductive angle sensors or as magnetic angle sensors. A combination of inductive angle sensors and magnetic angle sensors is possible too. The two angle sensors that provide the two angle signals for the first nonius calculation can be embodied as inductive angle sensors, for example, and the further angle sensor that provides the further angle signal for the second nonius calculation can be embodied as a magnetic angle sensor.

In an advantageous configuration of the sensor arrangement, the transmission ratio of the individual angle sensors is not an integer multiple of the transmission ratio of another angle sensor of the at least three angle sensors. The non-integer ratio can be used to increase the resolution of the angle measurement or the uniqueness range depending on the requirements of the respective application. The transmission ratios of the individual angle signals can be reduced or increased relative to the rotational movement of the shaft. This means that the individual periods of the at least three angle signals are smaller than or larger than one mechanical revolution of the rotatable body and thus less than or more than 360 degrees.

In another advantageous configuration of the sensor arrangement, at least one of the at least three electrical angle signals can have a fractional rational transmission ratio relative to the mechanical rotational movement of the rotatable body, so that the first uniqueness range or the second uniqueness range is greater than one revolution of the at least one rotatable body. This makes it possible to clearly identify angles of rotation that exceed one revolution, i.e. exceed an angle of rotation of 360 degrees. Preferably, the further electrical angle signal can have the fractional rational transmission ratio relative to the mechanical rotational movement of the rotatable body, so that the second uniqueness range of the determined second angle is greater than one revolution of the at least one rotatable body.

In another advantageous configuration of the sensor arrangement, the at least one evaluation and control unit can further be designed to carry out the second nonius calculation as a weighted nonius calculation and to weight the determined first angle higher than the further electrical angle signal. This is advantageous in particular when the third angle signal has the fractional rational transmission ratio and is mechanically reduced. The weighting in the second nonius calculation can then preferably be set to almost or exactly 100% of the angle determined by means of the first nonius calculation, while the third angle signal can be used only to count the revolutions of the rotatable body or for period correction. This enables simple compensation of hysteresis errors in the mechanical reduction of the rotational movement of the rotatable body.

In another advantageous configuration of the sensor arrangement, the transmission ratio of the individual angle sensors can be specified by a periodicity of the corresponding electrical angle signal. In the case of inductive angle sensors, the periodicity can easily be implemented via a number of the electrically conductive coupling segments of a corresponding coupling device. The transmission ratio of the individual angle sensors can alternatively be specified by a mechanical transmission of the rotational movement of the rotatable body to a further rotatable body, so that the further rotatable body rotates at a different speed than the rotatable body. The mechanical transmission can be implemented by a simple gear mechanism or by a planetary gear, for example.

In another advantageous configuration of the sensor arrangement, the at least one evaluation and control unit can be designed to ascertain, from a first electrical angle signal of a first angle sensor and a second electrical angle signal of a second angle sensor, a difference angle from which an effective torque on the rotatable body can be ascertained. The rotatable body can be embodied as a steering shaft of a vehicle, for instance. The first electrical angle signal of the first angle sensor can represent an angle of rotation of a first section of the steering shaft, and the second electrical angle signal of the second angle sensor can represent an angle of rotation of a second section of the steering shaft, so that the torque acting on the steering shaft can be ascertained. Since torque is measured on the basis of the first angle signal and the second angle signal, these angle signals have an application-related and torque-dependent difference angle that should be corrected for the first nonius calculation. Depending on the selected reference, this can also apply to the third electrical angle signal, so that a difference angle correction of the third electrical angle signal can be carried out before the second nonius calculation as well. In this case, the at least one evaluation and control unit can be further designed to carry out a difference angle correction of the first electrical angle signal and/or the second electrical angle signal and/or the third electrical angle signal before the corresponding nonius calculation. The difference angle corrections make it possible to ensure the robustness of the nonius calculations, because no “angular jumps” can occur in the determined angles. The monitorability of the nonius calculations in terms of functional safety can be ensured as well (“k-decimal place” monitoring). The difference angle correction by the defined reference for the second angle also enables greater accuracy of the rotation angle determination.

In another advantageous configuration of the sensor arrangement, a first evaluation and control unit can be designed to carry out the first nonius calculation and/or the difference angle calculation and/or the difference angle correction of the first electrical angle signal and/or the second electrical angle signal and/or the third electrical angle signal. A second evaluation and control unit can furthermore be designed to carry out the second nonius calculation. It is of course also possible to use only one evaluation and control unit to carry out these calculations.

Embodiment examples of the invention are shown in the drawings and explained in more detail in the following description. In the drawings, the same reference signs designate components or elements that perform the same or analogous functions.

### BRIEF DESCRIPTION OF THE DRAWINGS

FIG. 1 shows a schematic block diagram of a first embodiment example of a sensor arrangement according to the invention for acquiring a rotational movement of a body that can rotate about a rotational axis.

FIG. 2 shows a schematic block diagram of a second embodiment example of a sensor arrangement according to the invention for acquiring a rotational movement of a body that can rotate about a rotational axis.

FIG. 3 shows a schematic block diagram of an embodiment example of an evaluation and control unit for the sensor arrangement according to the invention of FIG. 1 or FIG. 2.

FIG. 4 shows a schematic flowchart of an embodiment example of a method according to the invention for acquiring a rotational movement of a body that can rotate about a rotational axis.

### EMBODIMENTS OF THE INVENTION

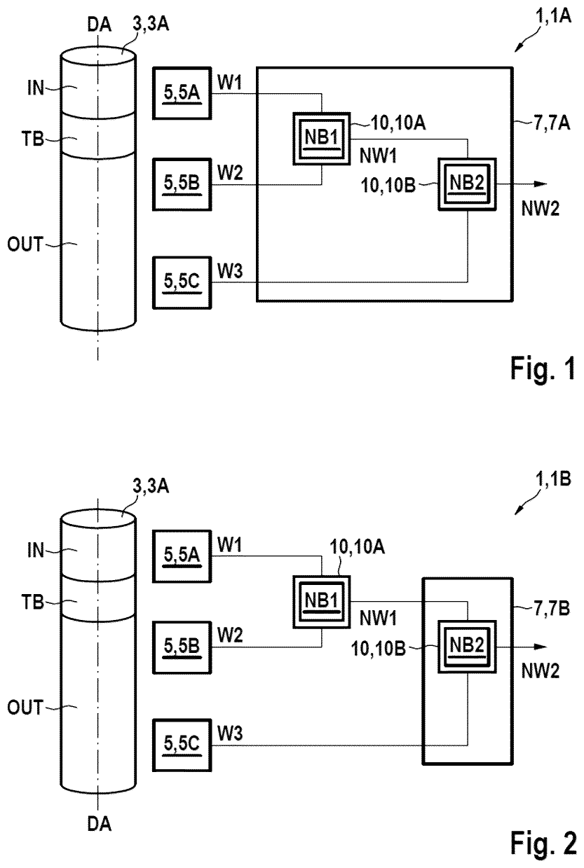

As can be seen from FIGS. 1 to 3, the shown embodiment examples of a sensor arrangement 1, 1A, 1B according to the invention for acquiring a rotational movement of a body 3 that can rotate about a rotational axis DA each comprise at least three angle sensors 5, 5A, 5B, 5C and at least one evaluation and control unit 10, 10A, 10B. The at least three angle sensors 5, 5A, 5B, 5C each acquire the mechanical rotational movement of the rotatable body 3 at a predefined transmission ratio and generate a corresponding electrical angle signal W1, W2, W3 and output said signal to the at least one evaluation and control unit 10, 10A, 10B, wherein the at least three angle sensors 5, 5A, 5B, 5C have different transmission ratios. The at least one evaluation and control unit 10, 10A, 10B determines a first angle NW1 of the rotatable body 3 with a first uniqueness range by means of a first nonius calculation NB1 that is based on two electrical angle signals W1, W2 of the at least three electrical angle signals W1, W2, W3. The first uniqueness range of the determined first angle NW1 is greater than the uniqueness ranges of the angle signals W1, W2 used for the calculation. The at least one evaluation and control unit 10, 10A, 10B also determines a second angle NW2 of the rotatable body 3 with a second uniqueness range by means of a second nonius calculation NB2 that is based on the determined first angle NW1 and a further electrical angle signal W3 of the at least three electrical angle signals W1, W2, W3. The second uniqueness range of the determined second angle NW2 is greater than the first uniqueness range of the determined first angle NW1 and a uniqueness range of the further electrical angle signal W3.

As can be further seen from FIGS. 1 and 2, the shown embodiment examples of the sensor arrangement 1, 1A, 1B each comprise three angle sensors 5A, 5B, 5C, two evaluation and control units 10A, 10B and a control device 7, 7A, 7B. In the shown embodiment examples, a first angle sensor 5A, which is embodied as an inductive angle sensor, provides a first electrical angle signal W1, a second angle sensor 5B, which is likewise embodied as an angle sensor, provides a second electrical angle signal W2, and a third angle sensor 5C, which is embodied as a magnetic angle sensor, provides a third electrical angle signal W3. In the shown embodiment examples, the two electrical angle signals W1, W2 of the two inductive angle sensors 5A, 5B are used for the first nonius calculation NB1 to determine the first angle NW1, which is carried out by a first evaluation and control unit 10A. In the shown embodiment examples, the third electrical angle signal W3 of the magnetic third angle sensor 5C is used with the determined first angle NW1 for the second nonius calculation NB2 to determine the second angle NW2, which is carried out by a second evaluation and control unit 10B. The transmission ratios of the three angle sensors 5A, 5B, 5C are selected such that the transmission ratio of the individual angle sensors 5A, 5B, 5C is not an integer multiple of the transmission ratio of another angle sensor 5A, 5B, 5C of the three angle sensors 5A, 5B, 5C. The transmission ratios of the two inductive angle sensors 5A, 5B are furthermore each specified by a periodicity of the corresponding electrical angle signal W1, W2. The transmission ratio of the magnetic third angle sensor 5C is specified by a not further depicted mechanical transmission of the rotational movement of the rotatable body 3 to a further rotatable body, so that the further rotatable body rotates at a different speed than the rotatable body 3.

At least one of the three electrical angle signals W1, W2, W3 has a fractional rational transmission ratio relative to the mechanical rotational movement of the rotatable body 3, so that the first uniqueness range or the second uniqueness range is greater than one revolution of the rotatable body 3. In the shown embodiment examples, the third electrical angle signal W3 of the magnetic third angle sensor 5C has the fractional rational transmission ratio relative to the mechanical rotational movement of the rotatable body 3, so that the second uniqueness range of the determined second angle NW2 is greater than one revolution of the at least one rotatable body 3.

In the shown embodiment examples, the first evaluation and control unit 10A carries out the second nonius calculation NB2 as a weighted nonius calculation. In this case, the determined first angle NW1 is weighted higher than the third electrical angle signal W3.

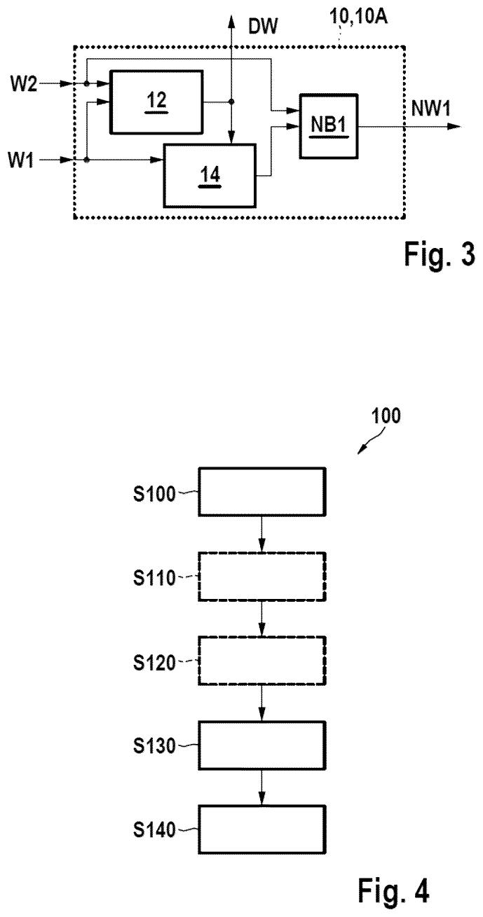

In the shown embodiment examples, the rotatable body 3 is embodied as a steering shaft 3A of a vehicle. The steering shaft 3A has a torsion region TB indicated with a dashed line. A not further depicted steering wheel is connected here to a first section IN or an input side of the steering shaft 3A which is disposed above the torsion region TB. A steering gear, which is connected to the wheels and is not shown in more detail, is connected to a second section OUT or an output side of the steering shaft 3A which is disposed below the torsion region TB. As can further be seen from FIG. 3, in a calculation block 12, the first evaluation and control unit 10A ascertains. from the first electrical angle signal W1 of the inductive first angle sensor 5A, which acquires an angle of rotation of the first section IN of the steering shaft 3A, and the second electrical angle signal W2 of the second angle sensor 5B, which acquires an angle of rotation of the second section OUT of the steering shaft 3A, a difference angle DW from which an effective torque on the rotatable body 3 embodied as steering shaft 3A can be ascertained. Before the first nonius calculation NB1, in a correction block 14, the first evaluation and control unit 10A also carries out a difference angle correction of the first electrical angle signal W1.

As can be further seen from FIG. 1, the shown first embodiment example of the sensor arrangement 1A comprises a first embodiment example of the control device 7A, in which the two evaluation and control units 10A, 10B are disposed. The two nonius calculations NB1, NB2 can thus be carried out in the control device 7A.

As can be further seen from FIG. 2, the shown second embodiment example of the sensor arrangement 1B comprises a second embodiment example of the control device 7B, in which only the second evaluation and control unit 10B is disposed. The first evaluation and control unit 10A is disposed outside the control device 7B near the two inductive angle sensors 5A, 5B.

As can be seen from FIG. 4, the shown embodiment example of a method 100 according to the invention for acquiring a rotational movement of a body 3 that can rotate about a rotational axis DA, which can be carried out with one of the above-described sensor arrangements 1, 1A, 1B, includes a step S100, in which at least three electrical angle signals W1, W2, W3 with a predefined transmission ratio are generated and evaluated on the basis of the mechanical rotational movement of the rotatable body 3, wherein the at least three electrical angle signals W1, W2, W3 are acquired with different transmission ratios. In a step S130, a first angle NW1 of the rotatable body 3 is determined with a first uniqueness range by means of a first nonius calculation NB1 that is based on two electrical angle signals W1, W2 of the at least three electrical angle signals W1, W2, W3. The first uniqueness range of the determined first angle NW1 here is greater than the uniqueness ranges of the angle signals W1, W2 used for the calculation. In a step S140, a second angle NW2 of the rotatable body 3 is determined with a second uniqueness range by means of a second nonius calculation NB2 that is based on the determined first angle NW1 and a further electrical angle signal W3 of the at least three electrical angle signals W1, W2, W3. In this case, the second uniqueness range of the determined second angle NW2 is greater than the first uniqueness range of the determined first angle NW1 and a uniqueness range of the further electrical angle signal W3.

If, after step S100, a difference angle DW, from which an effective torque on the rotatable body 3 can be determined, is ascertained from a first electrical angle signal W1 and a second electrical angle signal W2 in an optional step S110 indicated with a dashed line, then a further optional step S120 indicated with a dashed line is inserted before the first nonius calculation NB1 in step S130. In this case, a difference angle correction of the first electrical angle signal W1 and/or the second electrical angle signal W2 is carried out in step S120 before the first nonius calculation NB1 in step S130. The electrical angle signals W1, W2 are generally corrected with the calculated difference angle DW by addition or subtraction, taking into account the respective transmission ratio. Depending on whether the first angle signal W1 or the second angle signal W2 is being corrected, the angle reference for the calculation of the second angle NW2 is either the first section IN or the input side or the second section OUT or the output side. It is also possible to carry out the correction in a weighted manner in such a way that a virtual reference for the second angle NW2 is created between the first section IN or the input side and the second section OUT or the output side. This can be accomplished by averaging, for example, which corresponds to a correction of half the difference angle. Depending on the selection of the angle reference for the second angle NW2, a difference angle correction is also carried out with the third electrical angle signal W3.

In the shown embodiment example, the second electrical angle signal W2 is the angle reference for the first nonius calculation NB1. Therefore, a difference angle correction of the first electrical angle signal W1 is carried out in step S120. Depending on the selected angle reference and the arrangement of the third angle sensor 5C, a difference angle correction of the third electrical angle signal W3 is additionally carried out before the nonius calculations NB1, NB2 in step S120. In the shown embodiment example, no difference angle correction of the third electrical angle signal W3 is carried out, because the third electrical angle signal W3, like the second electrical angle signal W2, which is the angle reference for the first nonius calculation NB1, represents an angle of rotation of the second section OUT or the output side of the steering shaft 3A. If the first electrical angle signal W1 is the angle reference for the first nonius calculation NB1, a difference angle correction for the second electrical angle signal W2 and the third electrical angle signal W3 is carried out in step S120. Of course, the difference angle correction of the third electrical angle signal W3 can alternatively be carried out in a further not depicted step between the first nonius calculation in step S130 and the second nonius calculation in step S140.

In the shown embodiment example of the method 100 according to the invention, three electrical angle signals W1, W2, W3 are generated and evaluated with a predefined transmission ratio in step S100 on the basis of the mechanical rotational movement of the rotatable body 3. In step S130, the first angle NW1 of the rotatable body 3 is determined with the first uniqueness range by means of a first nonius calculation NB1 that is based on a first electrical angle signal W1 and a second electrical angle signal W2. In step S140, the second angle NW2 of the rotatable body 3 is determined with the second uniqueness range by means of the second nonius calculation NB2 that is based on the determined first electrical angle signal W1 and a third electrical angle signal W3.

Since the third angle signal W3 has the fractional rational transmission ratio and is mechanically reduced, the second nonius calculation NB2 is carried out as a weighted nonius calculation. In this case, the determined first angle NW1 is weighted higher than the third electrical angle signal W3 when determining the second angle NW2, because the third electrical angle signal W3 is used only to count the revolutions of the rotatable body embodied as steering shaft 3A. The determined second angle NW2, which represents an absolute angle of rotation of the rotatable body 3, can therefore be used to acquire multiple revolutions of the steering wheel.

1. A sensor arrangement for acquiring a rotational movement of a body that can rotate about a rotational axis, comprising at least three angle sensors and at least one evaluation and control unit, wherein:
the at least three angle sensors are each configured to acquire the mechanical rotational movement of the rotatable body with a predefined transmission ratio and generate a corresponding electrical angle signal and output said angle signal to the at least one evaluation and control unit,
the at least three angle sensors have different transmission ratios,
the at least one evaluation and control unit is designed to determine a first angle of the rotatable body with a first uniqueness range by way of a first nonius calculation that is based on two electrical angle signals of the at least three electrical angle signals,
the first uniqueness range of the determined first angle is greater than uniqueness ranges of the angle signals used for the calculation,
the at least one evaluation and control unit is further designed to determine a second angle of the rotatable body with a second uniqueness range by way of a second nonius calculation that is based on the determined first angle and a further electrical angle signal of the at least three electrical angle signals, and
the second uniqueness range of the determined second angle is greater than the first uniqueness range of the determined first angle and a uniqueness range of the further electrical angle signal.

2. The sensor arrangement according to claim 1, wherein the at least three angle sensors are each embodied as an inductive angle sensor or as a magnetic angle sensor.

3. The sensor arrangement according to claim 1, wherein the transmission ratio of the individual angle sensors is not an integer multiple of the transmission ratio of another angle sensor of the at least three angle sensors.

4. The sensor arrangement according to claim 1, wherein at least one of the at least three electrical angle signals has a fractional rational transmission ratio relative to the mechanical rotational movement of the rotatable body, so that the first uniqueness range or the second uniqueness range is greater than one revolution of the at least one rotatable body.

5. The sensor arrangement according to claim 4, wherein the further electrical angle signal has the fractional rational transmission ratio relative to the mechanical rotational movement of the rotatable body, so that the second uniqueness range of the determined second angle is greater than one revolution of the at least one rotatable body.

6. The sensor arrangement according to claim 1, wherein the at least one evaluation and control unit is further designed to carry out the second nonius calculation as a weighted nonius calculation and to weight the determined first angle higher than the further electrical angle signal.

7. The sensor arrangement according to claim 1, wherein the transmission ratio of the individual angle sensors is specified by a periodicity of the corresponding electrical angle signal.

8. The sensor arrangement according to claim 1, wherein the transmission ratio of the individual angle sensors is specified by a mechanical transmission of the rotational movement of the rotatable body to a further rotatable body, so that the further rotatable body rotates at a different speed than the rotatable body.

9. The sensor arrangement according to claim 1, wherein the at least one evaluation and control unit is designed to ascertain, from a first electrical angle signal of a first angle sensor and a second electrical angle signal of a second angle sensor, a difference angle from which an effective torque on the rotatable body is ascertained.

10. The sensor arrangement according to claim 9, wherein the at least one evaluation and control unit is further designed to carry out a difference angle correction of the first electrical angle signal and/or the second electrical angle signal and/or the third electrical angle signal before the corresponding nonius calculation.

11. The sensor arrangement according to claim 1, wherein a first evaluation and control unit is designed to carry out the first nonius calculation and/or the difference angle calculation and/or the difference angle correction of the first electrical angle signal and/or the second electrical angle signal and/or the third electrical angle signal.

12. The sensor arrangement according to claim 11, wherein a second evaluation and control unit is designed to carry out the second nonius calculation.

13. A method for acquiring a rotational movement of a body that can rotate about a rotational axis, which can be carried out using a sensor arrangement according to claim 1, wherein:
at least three electrical angle signals are generated and evaluated with a predefined transmission ratio on the basis of the mechanical rotational movement of the rotatable body,
the at least three electrical angle signals are acquired with different transmission ratios,
a first angle of the rotatable body is determined with a first uniqueness range by way of a first nonius calculation which is based on two electrical angle signals of the at least three electrical angle signals,
the first uniqueness range of the determined first angle is greater than uniqueness ranges of the angle signals used for the calculation,
a second angle of the rotatable body with a second uniqueness range is determined by way of a second nonius calculation which is based on the determined first angle and a further electrical angle signal of the at least three electrical angle signals, and
the second uniqueness range of the determined second angle is greater than the first uniqueness range of the determined first angle and a uniqueness range of the further electrical angle signal.

14. The method according to claim 13, wherein, from a first electrical angle signal and a second electrical angle signal, a difference angle is ascertained from which an effective torque on the rotatable body is ascertained.

15. The method according to claim 14, wherein a difference angle correction of the first electrical angle signal and/or the second electrical angle signal and/or the third electrical angle signal is carried out before the corresponding nonius calculation.
